(19) United States
(12) Patent Application Publication
(10) Pub. No.: US 2012/0058264 A1
(43) Pub. Date: Mar. 8, 2012

(54) SPRAYING DEVICE AND METHOD

(76) Inventors: Gregory Filou, Manneville sur risle (FR); Denis Huze, Fontaine Sous Jouy (FR); Aline Thomas, Serquigny (FR)

(21) Appl. No.: 13/266,289

(22) PCT Filed: Apr. 22, 2010
(86) PCT No.: PCT/FR10/50775

§ 371 Date: Nov. 21, 2011

(30) Foreign Application Priority Data
Apr. 29, 2009 (FR) 0952824

(51) Int. Cl. B05D 7/22; B05C 19/04

(52) U.S. Cl. 427/181; 118/308

(57) ABSTRACT

The present invention relates to a spraying nozzle, a spraying device including such a nozzle, and a spraying method implementing such a device. A nozzle for projecting powdery sold products for coating objects. The nozzle comprises a body having an essentially cylindrical shape and comprises at least two tunnels extending there through and insulated from each other. Each tunnel developing helically about a main axis of the nozzle. The tunnels are independently supplied with a fluid/powdery solid(s) mixture. The helical shape of the tunnels makes it possible to obtain a powerful jet with a conical shape capable of coating the inner surfaces of tubular objects.

### TECHNICAL FIELD OF INVENTION

The present invention refers to the field of spraying of powdery products form, in order to coat objects, in particular metal objects. More precisely, the present invention refers to a spraying nozzle, a spraying device comprising such a nozzle, as well as a spraying method using such a device.

### BACKGROUND OF THE INVENTION

Several techniques are known for forming a coat on an object, based on a powdery material. For example, fluidized bed sintering is usually employed for coat tubes. However, this technique forces to cover at the same time the internal wall and the external wall of the tubes.

Spraying techniques are also known. They advantageously make it possible to treat independently each wall of a tube. One can for example cover only the internal wall of said tube.

Electrostatic powdering is in particular known: the powder is charged in static electricity by its passage through a gun made out of a suitable material. Thus is in particular the case of the phenomenon of triboelectrification, which corresponds to a transfer of electrons between two surfaces in contact with one another, said surfaces being made of materials of different nature. The powder thus charged is then sprayed onto the object to be covered, this object being connected to a null potential. A powder layer is formed on the object, said layer being maintained by triboelectric charges. The covered object is then placed in a furnace, at a temperature higher than the melting point of the powder. The film forming method with said powder then forms a homogeneous coat.

Another technique, known as hot powdering technique, consists in heating the object to be covered at a temperature higher than the melting point of the powder. The powder is then sprayed on the object, immediately melts at the time of the contact and forms a film.

These techniques are described for example in the documents U.S. Pat. No. 5,173,327, FR2583310 and FR2185938 concerning electrostatic powdering and JP56062577 concerning hot powdering.

The spraying device described in these documents include a spraying nozzle. This nozzle aims at forming a powder jet mixed with a fluid, said fluid being generally compressed air. The configuration of the spraying nozzle is an element determining the form of the powder jet. Said form of the powder jet influences the characteristics of the coat layer, in particular the homogeneity and the thickness of said layer.

The most effective form of the powder jet to be used depends in particular on the piece to be covered. The document FR2185938 describes for example a nozzle making it possible to obtain a flat fan-shaped jet. This jet shape is in particular of an interest for covering pieces comprising elongated recesses. This jet shape, in two dimensions, however is not adapted to the spraying of the interior of a cylindrical tube. This type of surface indeed requires a projection in three dimensions.

The document U.S. Pat. No. 5,173,327 describes a nozzle making it possible to obtain a conical jet of form, adapted to the coating of the interior of a tube. This nozzle comprises a supply channel connected to several outlet sleeves in a conical arrangement. This type of configuration induces differences in pressure along the trajectory of the powder, these differences being able to generate an irregularity of the jet. Moreover, the powder flow is limited by the diameter of the single supply channel.

### OBJECT AND SUMMARY OF THE INVENTION

The present invention makes it possible to solve these problems. It makes it possible moreover to obtain a regular jet, with an important powder flow, a good output compared to the flow of fluid and a homogeneous covering of the interior of tubular pieces. An object of the invention is indeed a spraying nozzle for powdery solid products intended for coating objects, said nozzle comprising a substantially cylindrical body, characterized in that at least two tunnels, isolated one from the other, are provided right through the body, each tunnel helically extending around a main axis of the nozzle.

The expression “right through” means that the ends of the tunnels open onto walls oriented substantially perpendicular to the main axis of the nozzle. More precisely, for an substantially cylindrical body, the ends of the tunnels are located on bases of the cylinder and not on a side surface of said cylinder. In the description below, the terms “input” or “input end” of the nozzle, as well as the terms “output” or “output end” of the nozzle, indicate said walls substantially perpendicular to the main axis of the nozzle.

The helical shape of the powder spraying tunnels allows, at the output of the tube, to give said powder a direction having a side component. For example, when the nozzle is placed inside a cylindrical tube, coaxially with said tube, the powder is sprayed towards the internal wall of said tube, in an oblique way relative to the axis of the tube.

It is known in the state of the art to give the tunnels the shape of an arc at the output, said output of the tunnels opening onto a side wall of the nozzle. Thus, the jet is oriented in the direction of the internal wall of the tube. However, this arc shape implies a brutal change of direction of the powder at the output of the nozzle and thus a loss of energy. On the contrary, in the case of a helical displacement, a centrifugal force is imparted to the jet. The invention thus makes it possible to obtain a more powerful jet for the same pressure of fluid.

As the powder spraying tunnels are isolated one from the other, it is possible to supply them in an independent way. Another object of the invention is indeed a spraying device for powdery solid products intended for coating objects, comprising a spraying nozzle as described above, characterized in that each tunnel is connected, at the input of the tube, to an individual supply of powdery solid/fluid mixture(s). Preferentially, the fluid is compressed air.

These individual supplies make it possible to ensure a regular pressure along the trajectory of the powder, which improves the homogeneity of the jet.

As each supply is autonomous and as each tunnel is independent up to the output of the nozzle, it is possible to supply each tunnel with a different powder. For example, it is possible to supply each tunnel with a powder of different color. This aspect of the invention makes it possible to study the covering of pieces by visualizing, thanks to the various colors, the amplitude of said covering. It is thus easier to optimize the spraying device and method for a tube of a given diameter.

According to a preferential embodiment of the invention, a central orifice, substantially coaxial to said body, is provided right through the body of the nozzle. This orifice is particularly intended to be supplied with a fluid. Preferentially, the central orifice is connected, at the input of the nozzle, to an individual supply of fluid, for example of compressed air.

The air flow at the output of the nozzle through the central orifice tends to orient the powder flow laterally, in order to prevent said powder from moving in the direction of the axis of the nozzle. For the same reason, a preferential shape of the invention provides a deflector at the output of the nozzle. A part of said deflector substantially has the shape of a truncated cone coaxial with the body, the truncated cone widening as one moves away from the body along the main axis of the nozzle. Such a deflector is preferentially inserted into the central orifice.

According to a preferential embodiment of the invention, at least a tube is provided through the body of the nozzle, a first end of said tube opening inside the central orifice, a second end of said tube opening outside the body, an average area of the cross-section of said tube being at the most equal to 25% of an average area of the cross-section of a tunnel.

This or these tube(s) can open onto the output of the nozzle. They can be supplied with flows of fluid coming from the central orifice. Preferentially, a part of these tubes has a helical shape, similar to the shape of the tunnels.

These flows of fluid make it possible to modulate the trajectories of the powder leaving the spraying tunnels. They also make it possible to prevent the powder from agglomerating or from clogging on an external wall of the deflector.

A nozzle according to the invention can be adapted to hot powdering as well as to electrostatic powdering.

When using electrostatic powdering, it is possible to make the body of the nozzle out of a material which can generate an exchange of triboelectric charge with powdery material(s). One can in particular make the nozzle out of polytetrafluoroethylene (PTFE).

In the case of hot powdering, the nozzle is in particular placed inside a tube heated at a temperature higher than the melting point of the powder. The nozzle itself must thus be able to withstand such a high temperature.

It is possible to make the various elements of the nozzle from a material of high melting point, like a metal. However, according to a preferential embodiment of the invention, the nozzle is made out of a polymeric material of polyamide type. This type of material is likely to melt at the temperature inside the tube.

According to a preferential embodiment of the invention, the body of the nozzle is provided with a cooling cage. Such a cage is composed of an envelope covering an external side surface of the body of the nozzle. Preferentially, said envelope is perforated with at least one hole; said hole is located opposite a space between the external side surface of the body of the nozzle and an internal side surface of the envelope, said space being opposite a second end of a tube.

Such a tube can be supplied with a air flow coming from the central orifice. The envelope and the body of the nozzle are convection cooled by this air flow, circulating through the space between both surfaces. The envelope maintains the body of the nozzle at a temperature lower than that of the interior of the object to be sprayed.

According to a preferential embodiment of the invention, the nozzle is provided with a tubular head at its input end, said head being inserted into a part of the central orifice, a side wall of the head being perforated with at least one channel, an end of said channel being coplanar with a first end of a tube in a plane perpendicular to the main axis of the nozzle. The function of such a head is to distribute air flows between the various tubes opening into the central orifice, in particular between the tubes modulating the trajectories of the powder and those supplying the cooling cage.

The various elements of the nozzle, such as the body, the head or the deflector, can be made out of various materials and according to various methods. However, a laser sintering method is particularly advantageous to make the body of the nozzle. The presence of the helical tunnels makes indeed difficult the machining of such a piece. Laser sintering makes it possible to make a monobloc body. The head and the deflector can also be produced by laser sintering.

A laser sintering method is in particular described in the document FR2828422. This method uses a device controlled by a computer in order to make three-dimensional objects layer by layer, starting from a laser fusible powder. A laser irradiates selected sites of each layer to dissolve the powder. Various materials can be used for laser sintering, in particular PTFE, polyetherketone, poly(etheretherketone) or PEEK, poly(etherketoneketone) or PEKK, poly(etheretherketoneketone), fluorinated polymers like polyvinylidenefluoride or PVDF and polyamides like polyamide 11 or polyamide 12. Some metals like aluminum, or metal alloys such as steel or copper alloys, can also be used.

Materials used for manufacturing the nozzle according to the invention can moreover include charges such as mineral or organic charges, fibers, balls or particles of glass, carbon, boron, of ceramics, powder of aluminum, nano-charges, nano-clays or nanotubes of carbon. These charges make it possible to improve mechanical properties, like stress at break and stretch at break, of a nozzle made by powder fusion.

Powdery materials used for manufacturing of the tube according to the invention can moreover include additives. They can in particular include fluidization agents, such as silica powder; anti-UV agents; antioxidants; dyes; pigments; bactericides; fireproof agents, in particular those containing phosphorus, such as an organic phosphinate of a metal and/or ammonium polyphosphate.

According to a preferential embodiment of the invention, the body of the nozzle is made out of a material chosen among polyamide, PTFE, PEEK, PEKK and PVDF. These materials have a relatively low density indeed. As it will be described in details thereafter, a low-weight nozzle has the advantages at the time of spraying.

According to another preferential embodiment of the invention, the body of the nozzle is made out of metal. Metal is in particular preferred for the nozzles intended for the internal coating of tubes of small diameter by hot powdering. Indeed, the temperatures inside the tubes to be covered can be too high for a polyamide nozzle, in spite of the presence of a cooling system. It is in particular the case when the diameter of the tube is close to that of the nozzle used.

The object of the invention is also a method of coating the interior of a tubular object, comprising a step in which a powdery solid is sprayed inside said tubular object by means of a device as described previously, the spraying nozzle being moved axially inside the tubular object, or the tubular object being moved axially around the nozzle.

According to the invention, it is indeed useless to impart a rotational movement to the tube or the nozzle to ensure a homogeneous recovery of the interior of the tube. An axial displacement is sufficient. The relative speed of displacement of the nozzle relative to the tube, the diameter of the tube and the pressure of fluid condition the thickness of the powder layer deposited.

### BRIEF DESCRIPTION OF THE DRAWINGS

The invention will be better understood from the reading of the following description and the examination of the annexed figures. Those are given as an indication and by no means a limitation of the invention. The figures show:

FIG. 1 is a perspective view of an axial cross-section of the body of a nozzle according to an embodiment of the invention;

FIG. 2 is a view of the output end of said nozzle body;

FIG. 3 is an axial cross-section of a nozzle according to an embodiment of the invention;

FIG. 4 is a diagram of a spraying device according to an embodiment of the invention; and

FIG. 5 is a graph representing the speed of displacement of a tube relative to said device according to the internal diameter of said tube, to obtain a coat with a given thickness, by means of a method according to an embodiment of the invention.

### DETAILED DESCRIPTION OF THE EMBODIMENTS

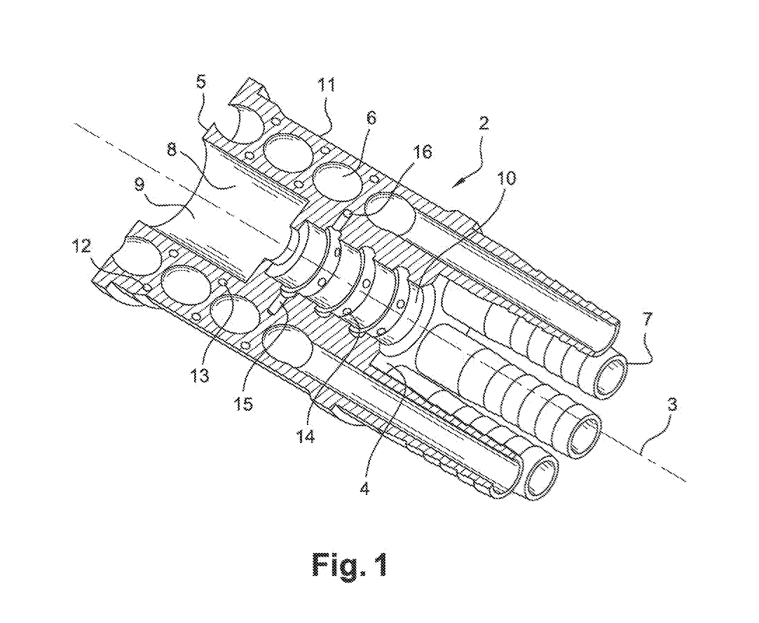

FIG. 1 is a perspective view of an axial cross-section of a body 2 of a nozzle 1 according to an embodiment of the invention. The external shape of the body 2 is substantially a cylinder of revolution, along an axis 3. The body 2 of the nozzle has an input end 4 and an output end 5. Tunnels 6, whose ends open respectively into the input end 4 and the output end 5, are provided right through the body 2.

Tunnels 6 are of identical shape and dimension. They are arranged according to a symmetry of rotation relative to the axis 3. The tunnels 6 extend while forming circular helixes, having identical steps, around the axis 3. The tunnels 6 have a substantially elliptic section.

The number of tunnels 6 depends in particular on the internal diameter of the tubular pieces that the nozzle 1 is intended to cover. For tubular pieces of low diameter, two tunnels 6 can be sufficient. Preferentially, the number of tunnels 6 lies between three and sixteen. In the example represented in FIG. 1, there are eight tunnels.

At the input 4 of the body 2, each tunnel 6 is prolonged by a head 7, which makes it possible to connect said tunnel 6 to a supply of fluid/solid powdery mixture. Each head 7 is oriented parallel to the axis 3 of the body 2. While entering the nozzle 1, a flow of fluid/solid powdery mixture(s) moves in the direction of the axis 3. Its input into a tunnel 6 make it displace helically. At the output 5 of the nozzle 1, the flow thus has an oblique direction relative to the axis 3. Moreover, a centrifugal force is imparted to the powder particles during their helical displacement. All the flows out of the tunnels 6 at the output 5 of the nozzle thus form a conical jet. This jet shape allows a homogeneous covering of the interior of a tube in which the nozzle 1 can be placed.

In a preferential way, an angle formed by the axis 3 and a tangent of a directrix of a helical tunnel 6 lies between 30° and 60°. More preferentially, said angle lies between 40° and 50°.

Moreover, a central orifice 8, substantially coaxial to said body 2, is provided right through the body 2. As represented in FIG. 1, the orifice 8 can have a variable shape and diameter over its length, said length lying between the input 4 and the output 5 of the nozzle.

In the example represented in FIG. 1, the orifice 8 comprises a substantially cylindrical part 9, located near the output 5 of the nozzle. Moreover, the orifice 8 comprises a substantially cylindrical part 10, located near the input 4 of the nozzle. The parts 9 and 10 have different average diameters.

The internal surfaces of the parts 9 and 10 have the shape complementary to pieces able to be inserted in said parts 9 and 10. These pieces will be described thereafter.

In a preferential way, over the length of the central orifice 8, an internal diameter of said orifice remains between 20% and 60% of an external diameter of the body 2. The helical tunnels 6 extend in a space between the orifice 8 and an external side surface 11 of the body 2.

Moreover, tubes (12, 13) are provided through the body 2. A first end 14 of said tubes open into the central orifice 8, more particularly at the part 10. A part 15 of the tubes (12, 13) is substantially rectilinear, oriented perpendicular to the axis 3. Said part 15 ends in an elbow 16, from which the tube 12 or 13 extends while forming a circular helix around the axis 3, in the direction of the output 5 of the body 2. In a preferential way, the helix formed by a tube 12 or 13 has a step substantially equal to the step of the helix formed by a tunnel 6. An external tube 12 extends in a space between the tunnels 6 and the external side surface 11 of the body. A internal tube 13 extends in a space between the tunnels 6 and the central orifice 8.

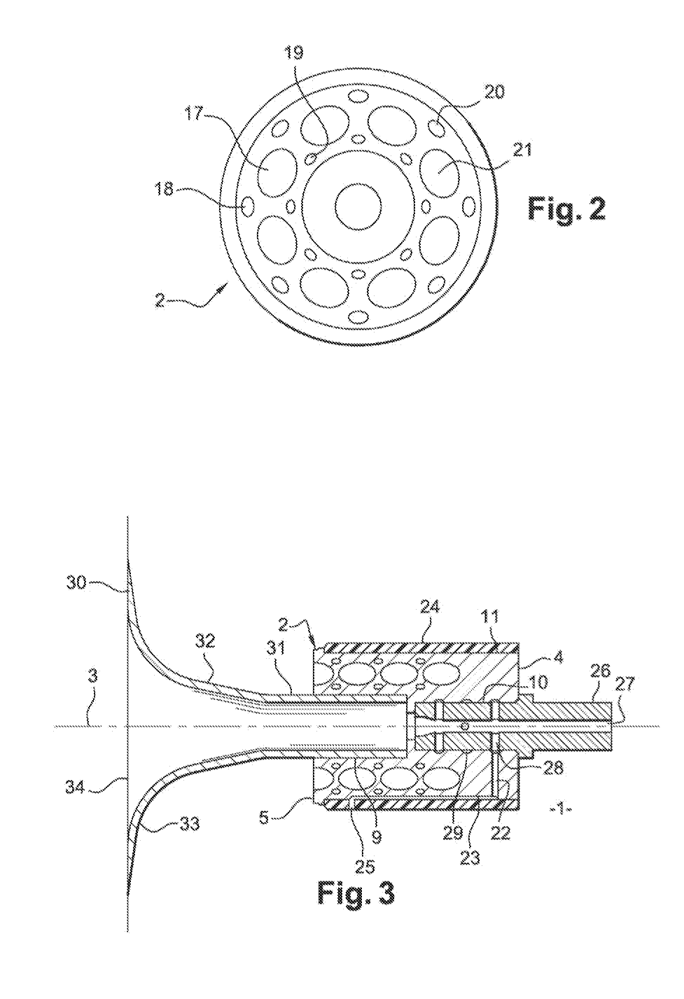

FIG. 2 is a view of the output end 5 of the body 2. One can see the output ends 17 of the tunnels 6, the output ends 18 of the external tubes 12 and the output ends 19 of the internal tubes 13. The ends 19, 17 and 18 are respectively arranged according to three concentric circles of increasing radius.

Tubes (12, 13) are intended to be supplied with a fluid, through the central orifice 8. The function of the flows of fluid, in particular of compressed air, out of the tubes (12, 13) is to modulate the trajectory of the flow of fluid/powder mixture leaving the tunnels 6. The nozzle can comprise a piece, described thereafter, whose function is to control the supply of fluid into the tubes (12, 13).

In a preferential way, the number of external tubes 12 and the number of internal tubes 13 are equal to the number of tunnels 6. In a preferential way, the ends (18, 19) of said tubes are arrange in staggered rows relative to the output ends 17 of the tunnels 6. Such an arrangement is represented in FIG. 2.

An average area 20 of the cross-section of a tube 12 or 13 is significantly lower than an average area 21 of the cross-section of a tunnel 6. An average area 20 is in particular lower than or equal to 25% of an average area 21. Preferentially, an average surface 20 is lower than or equal to 15% of an average surface 21.

FIG. 3 is an axial cross-section of a tube 1 according to an embodiment of the invention. The nozzle 1 comprises in particular a body 2 as represented in FIGS. 1 and 2.

The external side surface 11 of the body 2 is surrounded by an envelope 24, which conforms to a part of said surface 11. A space, here a groove 23, lies between another part of the surface 11 and an internal surface of the envelope 24.

In the example represented in FIG. 3, the groove 23 extends in the surface 11 in a direction parallel to the axis 3. It is however possible to give a different shape to said groove. The surface 11 can also comprise several grooves 23. The space between the surface 11 and the envelope 24 can also go around the body 2, for example in a symmetrical way of revolution around the axis 3. The space can be provided by a hollow in the surface 11, as for example the groove 23. Said space can also be provided by a hollow in the internal surface of the envelope 24.

A tube 22 is provided in the body 2, said tube being substantially perpendicular to the axis 3. A first end of the tube 22 opens into the central orifice 8, at the part 10. A second end of the tube 22 opens into the space between the surface 11 and the envelope 24. The tube 22 opens in particular into the groove 23 provided in the surface 11.

The envelope 24 comprises a hole 25, opposite the groove 23. A fluid such as compressed air, coming from the central orifice 8, can flow through the tube 22. The fluid circulates then through the groove 23, in contact with an internal surface of the envelope 24. A transfer of heat can thus take place between the fluid and the envelope 24, like between the fluid and the surface 11 of the body 2. The fluid leaves then the nozzle 1 through the hole 25 provided in the envelope 24.

When the nozzle 1 is placed in an environment at a high temperature, the envelope 24 and the body 2 can be cooled by convection. The cooled envelope 24 then contributes to cool the body 2. The envelope 24 fulfills the function of a cooling cage for the nozzle 1.

Various materials can be used to make the envelope 24. In a preferential way, said envelope is made out of metal.

At its input end 4, the nozzle 1 is provided with a tubular end 26, insert in the part 10 of the central orifice 8. The head 26 is provided therein with a main channel 27, coaxial with the body 2. The head 26 is also provided therein with secondary channels 28, perpendicular to the axis 3. An end of the channels 28 opens into the main channel 27, the other end opens into the part 10 of the orifice 8. The secondary channels 28 are coplanar at ends of the tubes 12, 13 or 22. When rotating the head 26 around the axis 3, an end of a channel 28 can be placed opposite an end of a tube 12, 13 or 22.

The central opening 8 can be supplied or not with a fluid. When sans orifice 8 is supplied, the tubes 12, 13 or 22 are supplied or not with a fluid, according to the presence or the absence of a channel 28 opposite an end of said tubes. The head 26 thus makes it possible to control the fluid distribution between the tubes (12, 13, 22).

According to an embodiment of the invention, first ends of the tubes 12 and/or 13 and/or 22 are coplanar in a plane perpendicular to the axis 3. Said ends open into a circular groove 29, provided into a surface of the part 10 of the orifice 8. Said groove can be coplanar with a channel 28. This groove 29 enable the same channel 28 to supply with a fluid the totality of the tubes 12 and/or 13 and/or 22 opening into said groove.

Various materials and methods can be used to manufacture the head 26. Said head can in particular be made by laser sintering, as well as the body 2. The materials adapted to laser sintering, previously mentioned, can be employed.

According to a preferential embodiment of the invention, as represented in FIG. 3, the nozzle 1 comprises a first deflector 30 at its output end 5. Such a deflector 30 aims at orienting the trajectory of the powder jet in a lateral direction. A deflector 30 comprises in particular a substantially cylindrical part 31, coaxial with the body 2, inserted into the part 9 of the central orifice 8. The deflector also comprises a part 32 having the shape of a truncated cone coaxial with the body 2, said part 32 prolonging the part 31. The truncated cone of the part 32 widens as one moves away from the body 2 along the axis 3.

It is possible to insert more or less the cylindrical part 31 into the orifice 8 of the body 2, in order to modulate the distance between the truncated part 32 and the output end 5 of the nozzle.

In the example represented in FIG. 3, the truncated part 32 is prolonged, at its most widened end, by a substantially annular part 33, substantially flat, perpendicular to the axis 3. It is also possible to prolong the truncated part 32 by a cylindrical part coaxial with the body 2, or by a part bent towards the outside of the truncated cone.

According to an embodiment of the invention, not represented, it is possible to provide the nozzle 1 with a second deflector. A part of such a second deflector substantially has the shape of a truncated cone coaxial with the body 2. Said body 2 is located inside said truncated cone. Said truncated cone widens in the opposite direction relative to the widening of the part 32 of the first deflector 30.

The use of two such deflectors makes it possible to confine the powder between both truncated cones, which accelerates the formation of a powder layer onto the internal surface of the tube to be covered.

Various materials and methods can be used to manufacture the deflector 30. In particular, said deflector can be produced by machining, or by laser sintering. The deflector can be made out of metal. Advantageously, the deflector 30 is made out of a polymer such as polyamide or PTFE. These materials are indeed lighter and more flexible than metal.

In order to avoid a powder return into the truncated part 32 of the first deflector 30, it is possible to cover the most widened end 34 of the deflector 30 with a porous material, whose size of the pores is lower than the size of the particles of the powdery solid intended to be sprayed with the nozzle 1. A fluid supply of the central orifice 8 then allows to remove the powder which can cover the porous material.

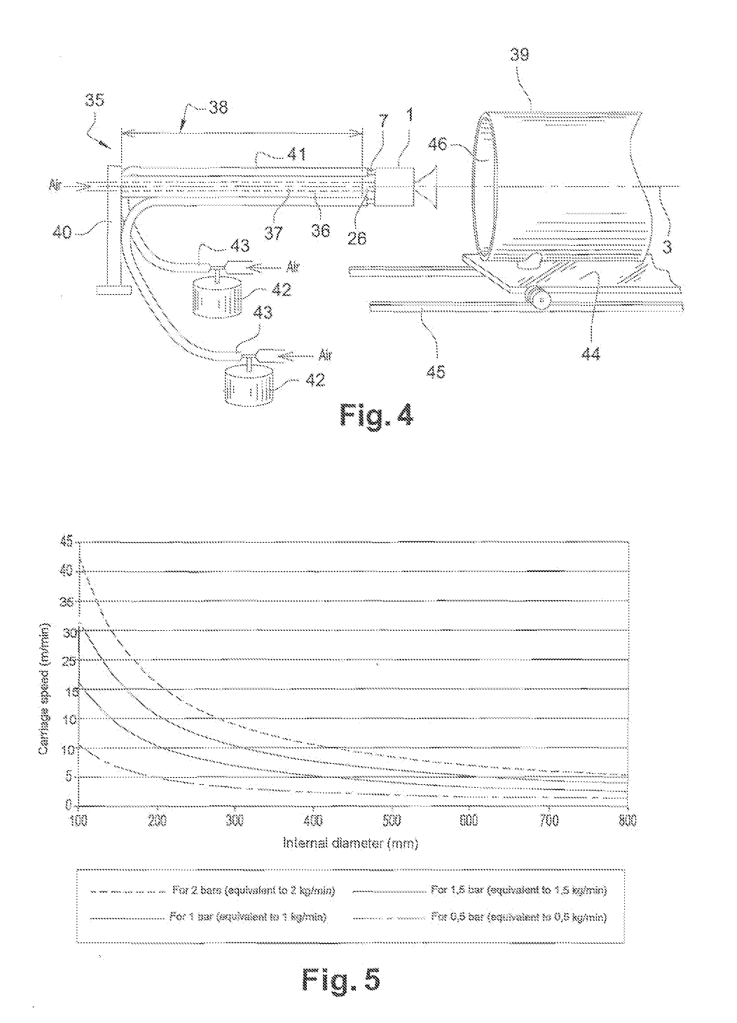

FIG. 4 shows a diagram of a spraying device according to an embodiment of the invention. Such a device is in particular intended to cover the interior of tubular objects by hot powdering. This device 35 comprises in particular a nozzle 1 such as previously described.

Moreover, the device 35 comprises a support stick 36, at an end of which the nozzle 1 is fixed. The stick 36 is coaxial with the axis 3 of the nozzle 1. Various solutions can be adopted to the stick 36 firmly to the nozzle 1. In the example represented in FIG. 4, the nozzle 1 is fixed to the stick 36 through the head 26. Said head is inserted into a conduit 37 which extends rightly through the stick 36. The conduit 37, coaxial with the stick 36 and the nozzle 1, is intended to supply the central orifice 8 with compressed air.

Conduits 41, intended to supply tunnels 6 with a fluid/powder mixture, can also be integrated into the stick 36. This solution makes it possible to optimize a thermal protection of said conduits 41.

However, in the example represented in FIG. 4, the conduits 41 are outside the stick 36 and are fixed to said stick on a part of their length.

In a preferential way, the stick 36 has a length 38 superior or equal to the length of a tube 39, whose interior is intended to be covered with powder by the device 35. The stick 36 and the tube 39 are arranged in a coaxial way relative to the axis 3.

At its end opposite the nozzle 1, the stick 36 is fixed to a support 40. Preferably, the stick 36 is self-supporting, i.e. it is over-mounted. It is also possible to provide the stick 36, near the nozzle 1, with legs which support the weight of said stick and of the nozzle 1.

Devices provided with such legs are known in the anterior art. These legs generally rest on rollers. When the tube 39 moves during coating, the rollers goes into said tube and can damage the preparation of the surface to be covered.

It is thus preferable to use a self-supporting stick 38, which the present invention allows. Indeed, according to a preferential embodiment of the invention, elements of the nozzle 1 are made out of polymer, in particular out of polyamide. For example, the body 2, the deflector 30 and the head 26 can be made out of polyamide 11. This material is relatively light. For example, a nozzle, such as previously described, made out of polyamide 11, can weigh approximately 200 g. It is possible for the stick 36 to support such a weight while remaining coaxial with the tube 39, even when said stick has an important length 38.

The tunnels 6 of the nozzle 1 are supplied with compressed air/powder mixture through the heads 7. In FIG. 4, only two heads 7 and two fuel supplies are represented. Each tunnel 6 is supplied individually by a conduit 41. Each conduit 41 is connected to a supply 42 of powder. The powder is for example taken by a Venturi aspiration system 43, through which flows compressed air and which is connected to the conduit 41.

It is possible to connect various conduits 41 to the same supply 42 of powder. However, according to a preferential embodiment of the invention, each conduit 41 has its own powder supplying system 43. Thus, each tunnel 6 is supplied in an independent way with a compressed air/powder mixture.

The supply 42 can consist of a powder bag, or of a fluidized bed. Inside a fluidized bed powder is in a fluidization state, in the presence of a gas such as air.

In a preferential way, the powder used by the device 35 has a low grain sizing, for example from 0.01 to 1 mm. For coating the interior of metal tubes, the powder can in particular be a thermoplastic polymer such as polyamide 11.

In order to cover the interior of a tube 39 with a thermoplastic film, the following method is for example used: the tube 39, previously heated, is moved along the axis 3 in the direction of the support 40 of the stick 36. The tube 39 is for example moved by means of a carriage 44 which rolls on rails 45. Said rails 45 are parallel to the axis 3 of the device 35.

Compressed air is sent into the powder taking systems 43, as well as into the conduit 37. A powder/compressed air mixture flows through the conduits 41, then through the heads 7, then through the helical tunnels 6 of the nozzle 1. Various flows through the tunnels 6 form, at the output of the nozzle, a conical jet which sprays the powder onto the internal wall 46 of the tube 39.

The speed of displacement of the tube 39, the diameter of said tube and the pressure of compressed air condition the thickness of the powder layer deposited. FIG. 5 shows a graph representing the speeds of displacement of the tube 39 according to the internal diameter of said tube, to obtain a polyamide 11 coat of 150 μm. The device used is that represented in FIG. 4. The measurements are carried out at several pressures, the pressure indicated being the total pressure of air for the eight powder supplies of the nozzle 1.

By using the same spraying tube, FIG. 5 shows that the more the tube 39 has a large diameter, the more the displacement of the tube must be slow to obtain the desired film thickness. A tube according to the invention makes it possible to obtain a powerful and homogeneous powder jet. It is thus possible to move the tubes more quickly than in known devices, for the same desired coat thickness. The device according to the invention offers a better productivity than spraying devices of the state of the art.

1-14. (canceled)

15. A spraying device for coating objects with powdery solid products, comprising a spraying nozzle, said nozzle comprising a body having a substantially cylindrical shape and provided therethrough with at least two tunnels isolated one from the other, each tunnel extending in a helical manner around a main axis of the nozzle and connected, at an input of the nozzle, to an individual supply of fluid/solid powdery mixture.

16. The device of claim 15, further comprising a central orifice substantially coaxial with the body and provided right through the body of the nozzle, the central orifice being connected to an individual fluid supply.

17. The device of claim 16, further comprising at least one tube provided through the body of the nozzle, a first end of said tube opening into the central orifice, a second end of said tube opening outside the body of the nozzle, an average area of the cross-section of said tube being at the most equal to 25% of an average area of the cross-section of a tunnel.

18. The device of claim 17, wherein the second end of said tube opens at an output end of the nozzle.

19. The device of claim 17, wherein the second end of said tube opens onto a side surface of the body of the nozzle.

20. The device of claim 17, wherein the nozzle comprises a tubular head at its input end, said input end being inserted into a part of the central orifice, a side wall of the tubular head being perforated with at least one channel, an end of said channel being coplanar with said first end of said tube in a plane perpendicular to the main axis of the nozzle.

21. The device of claim 19, wherein an external side surface of the body of the nozzle is covered with an envelope, said envelope being perforated with at least one hole, said hole being located opposite a space between an external side surface of the body of the nozzle and an internal side surface of said envelope, said space being opposite said second end of said tube.

22. The device of claim of claim 16, further comprising a first deflector at an output end of the nozzle, said first deflector being inserted into a part of the central orifice, a part of the first deflector having substantially the shape of a truncated cone coaxial with the body of the nozzle, the truncated cone part widening in a direction away from the body of the nozzle along the main axis of the nozzle.

23. The device of claim 22, wherein the truncated cone part of the deflector is prolonged, at its most widened end, by one of the following: a cylindrical part coaxial with the body of the nozzle; a substantially annular part, substantially flat, perpendicular to the main axis of the nozzle; or a part bent towards the outside of the truncated cone part.

24. The device of claim 22, further comprising a second deflector, a part of the second deflector having substantially the shape of a truncated cone coaxial with the body of the nozzle; and wherein the body of the nozzle being inside the truncated cone part of the second deflector, the truncated cone part of the second deflector widening in the opposite direction relative to the widening direction of the truncated cone part of the first deflector.

25. The device of claim 23, wherein the first deflector is covered with a porous material at its most widened end, the size of pores of the porous material is lower than the size of particles of the powdery solid.

26. The device of claim 15, wherein the body of the nozzle is made out of a material chosen among a metal, a polyamide, polytetrafluoroethylene, poly(etheretherketone), poly(etherketoneketone) and vinylidene polyfluoride.

27. The device of claim 15, wherein the body of the nozzle is made by laser sintering.

28. A method for coating interior of a tubular object utilizing the spraying device of claim 15, comprising the steps of spraying a powdery solid inside said tubular object with the spraying device; and moving the nozzle axially inside the tubular object or moving the tubular object axially around the nozzle.
